(19) United States
(12) Patent Application Publication
(10) Pub. No.: US 2003/0177028 A1
(43) Pub. Date: Sep. 18, 2003

(54) Method and apparatus for remotely altering an account

(76) Inventors: John Cooper, Tewksbury, MA (US); Thomas Erskine, Marblehead, MA (US); Brian Ducharme, Melrose, MA (US); Fritz von Mering, Winchester, MA (US); Dennis Turri, Burlington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/382,485

(22) Filed: Mar. 6, 2003

Related U.S. Application Data
(60) Provisional application No. 60/363,221, filed on Mar. 7, 2002.

(51) Int. Cl. G06F 17/60

(52) U.S. Cl. 705/1

(57) ABSTRACT

A system and methods for enabling access to one or more accounts associated with a Mobile Directory Number (MDN), wherein transactional tasks may be enacted, are disclosed. Such a system includes a server coupled to receive an input transaction request from a user through a point-of-entry device and coupled to a database that corresponds the MDN to the logical address of a user account. The server includes a processor for accessing the database to identify the logical address of the MDN-associated account. A method for using the system is also disclosed in which a user enacts a transaction with an account associated with an MDN. The method includes obtaining the MDN and transaction request from a point of entry device, identifying the account using a database that corresponds MDN with account logical address, and enacting the requested transaction on the identified account using access information obtained from the database.

### CROSS REFERENCE TO RELATED APPLICATIONS

This application claims priority of U.S. Provisional Patent Application No. 60/363,221, filed Mar. 7, 2002, the disclosure of which is incorporated herein by reference.

### STATEMENT REGARDING FEDERALLY SPONSORED RESEARCH OR DEVELOPMENT

N/A

### BACKGROUND OF THE INVENTION

In the past, a telephone directory number provided the dual function of identifying a customer as well as providing a network with the information necessary to properly route a call to the customer or to identify customer account information. This environment necessitates changing directory numbers when switching carriers. The Telecommunications Act of 1996, in an effort to open the local-exchange market to competition, mandated that wireline local exchange carriers (LECs) and local wireless carriers provide number portability (NP). NP service provides customers the ability to switch service providers while maintaining their same directory numbers. Wireline customers already enjoy NP support; wireless carriers are in the process of implementing NP support.

NP service is often realized in an architecture involving a NP database and a location routing number (LRN), the latter to uniquely identify each switch in a network. The NP database stores, in association, directory numbers and the LRN of the switch that currently serves that directory number. The NP database is notified and updated in real-time when a subscriber changes service providers so that the NP database maintains valid associations between directory numbers and LRNs. When a directory number is thus “ported” to another LEC or wireless carrier, the LRN of the switch used by that carrier is now associated with the corresponding directory number. In this way, the customer is permitted to keep one directory number without regard to the customer's current or future choice of service providers.

The NP environment is particularly advantageous for wireless customers. The convenience and simplicity of switching carriers while retaining the same cell phone number will drive down the cost of cellular service as wireless carriers compete to offer the best service at the lowest cost, thus facilitating use of the cellular phone as not only a personal communication device, but an integral tool in mobile commerce (mCommerce) and a convenient means to expedite mobile transactions.

An NP database essentially provides a correspondence between a telecommunications-related identifier of a user or entity, such as a telephone number, an active service provider, and ultimately associated account information. In addition to the benefits afforded by NP service in terms of consumer convenience, there are a variety of additional beneficial uses to which an NP or similar database can be put.

### BRIEF SUMMARY OF THE INVENTION

Applicants have identified and appreciated that NP service permits a shift towards viewing a user or entity identifier such as a Mobile Directory Number (MDN) as an individual identification of a particular customer and facilitates new and novel uses exploiting the location capabilities of the NP and similar databases. Location capabilities, in this context, refers to the ability to use correspondence information from such databases to identify, then establish communications with, the entity maintaining an account associated with the customer. In order to take advantage of these emerging technologies and changing paradigms, the invention is directed towards non-call uses of databases which, like the NP database, associate telecommunications-related customer identifiers with the respective customer account. In particular, aspects of the invention are directed towards access to one or more accounts associated with a mobile directory number, wherein transactional tasks may be enacted.

One embodiment of the present invention is directed towards a system that enables a user to carry out a transaction including a transfer of funds to/from an account associated with a mobile directory number. The system comprises a server coupled to receive an input transaction request from a user through at least one point-of-entry device and coupled to a number portability or similar database and thus to a user account. The server includes a processor that implements software such that when the input transaction request is received, the server accesses the database to identify how to access an associated account to carry out the transaction on the account.

Another embodiment of the present invention is directed towards a method for enabling a user to enact a transaction with at least one account associated with a mobile directory number. The method comprises acts of obtaining the mobile directory number and a transaction request from a user through at least one point of entry device, identifying the at least one account using information obtained by supplying the mobile directory number to a number portability or similar database, and enacting the requested transaction on the identified account using access information obtained from the database.

Another embodiment of the present invention is directed towards a system for enabling transactions with one or more accounts associated with a mobile directory number. The system comprises input means for receiving a mobile directory number and transaction information, identification means for identifying how to access an account associated with the mobile directory number from information obtained from a database, and transaction means for enacting a transaction on the account based on the transaction information.

### BRIEF DESCRIPTION OF THE SEVERAL VIEWS OF THE DRAWING

The invention will be more fully understood by reference to the following description in conjunction with the accompanying drawings of which:

FIG. 1 is a block diagram of one embodiment of apparatus for remotely altering an account according to the present invention;

FIGS. 2-8 are depictions of an Automated Teller Machine (ATM) during a recharge transaction enacted on an account associated with a Mobile Directory Number according to one embodiment of the present invention; and

FIG. 9 is a decision tree illustrating how a request to alter an account is processed according to the presently disclosed system and method.

### DETAILED DESCRIPTION OF THE INVENTION

By appreciating the opportunities that number portability avails, Applicants have identified various advantages and benefits gained from viewing a mobile directory number as a means for accessing one or more accounts associated with the mobile directory number.

One embodiment of the present invention relates to a non-call use of a Number Portability (NP) or similar database. In particular, an embodiment of the invention is directed to a system or method for accessing and modifying one or more accounts associated with a mobile directory number from one or more standard and/or mobile points of entry, including identifying the account from information obtained from a number portability or similar database. Wireless NP service facilitates utilizing a mobile directory number as an identification number, allowing one or more accounts to be associated and identified with that number. An account applies generally to any designated electronic space allocated to retain information and specified uniquely by some identification means. Examples include, but are not limited to, standard money accounts, electronic debit balance accounts, stored value accounts such as prepaid wireless or wireline communications service accounts, credit balance accounts such as wireless or wireline standard post-paid communications service accounts, information databases to store personal information such as names, numbers and addresses, and electronic portals to other databases, services and informational resources.

The number of standard banking transactions taking place at points other than the physical branch at a teller window is steadily increasing. The convenience afforded by Automated Teller Machines (ATMs), telephones, cellular telephones, Personal Computers (PCs) and other points of entry have made these transactional modes ubiquitous. A point of entry applies generally to any device or combination of devices capable of capturing input information and transmitting the information to a processor, network, server, or system of networks. Various embodiments of the present invention are directed towards availing the same transactional modes currently available for bank account transactions to account transactions associated with a mobile directory number.

According to one scenario that incorporates the present invention, an end-user has one or more accounts associated with a Mobile Directory Number (MDN) or similar identifier. The MDN is the user's 10 digit cellular telephone number. Associated accounts may include money accounts, information accounts, stored value accounts including for example prepaid wireless or wireline communications service accounts, credit balance accounts including for example wireless or wireline standard post-paid communications service accounts, etc. Using the MDN to identify one or more of the associated accounts, a user can retrieve information, transfer funds between accounts, and conduct status checks from any number of remote entry points, including but not limited to ATMs, PCs, cellular phones, and handheld devices. This allows an end-user to access information, enact mobile transactions, and conduct mobile commerce (so-called “mCommerce”) transactions from nearly anywhere and at anytime.

Preferably, the database employed in the system according to the present disclosure associates a user-identifier such as an MDN with an indication of how the system can access data in an associated user account. Access to such user accounts may be defined according to one of at least three scenarios.

First, a user may have an existing account established with a client of the entity operating the system of the present invention. One example of this scenario would be for a billing services provider to operate the presently disclosed system and for the client to be a wireless services carrier that uses the billing services provider for managing accounts of at least some of the carrier's subscribers. The user in this case would be a subscriber to the carrier's wireless services. For consistency, the following discussion refers to locally managed accounts as “domestic accounts.”

Second, the user account may be established with a company (e.g., a wireless services carrier) that is not a customer of the entity operating the system of the present invention (e.g., a billing services provider). Here, the carrier has enabled the billing services provider to have real-time access to accounts associated with the carrier's subscribers. Such a company is referred to herein as a “non-client company” and the remotely managed accounts are referred to as “foreign accounts.” It will be appreciated that client companies may also choose to maintain certain subscriber accounts as foreign accounts.

Third, the situation is the same as with the previous scenario, except that the client or non-client carrier has not given the billing services provider real-time access to the foreign subscriber accounts.

An NP variant of such a database associates MDN with switch address. While functional, this requires that up-to-date switch addresses be maintained in the NP database. In most cases, this information must be provided by multiple client and non-client entities, thus complicating the maintenance of the NP database.

A preferred alternative is a database that provides information on how the transaction means is to carry out account modification rather than simply defining literally where the account is. This approach provides the logical address of the account associated with an MDN along with queues for invoking the appropriate functionality to access such accounts. The database contents must be defined taking into consideration which of the three scenarios defined above is operative.

Following below are more detailed descriptions of various concepts related to, and embodiments of, methods and apparatus according to the present invention for altering an account associated with a mobile directory number.

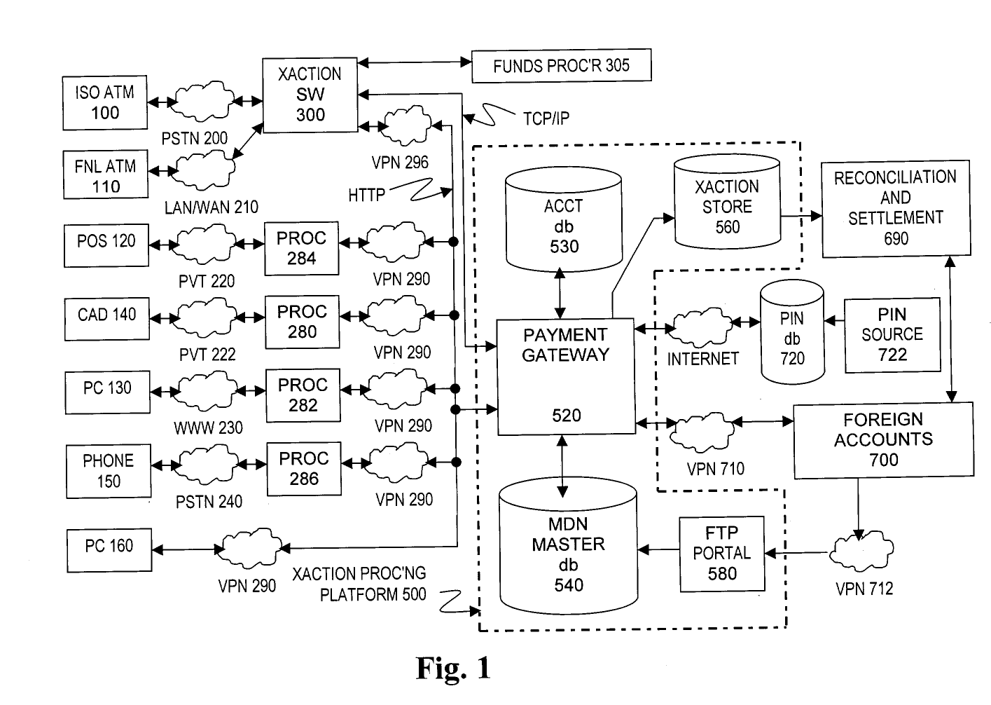

FIG. 1 illustrates one embodiment of a system that enables a user to remotely alter an account. In particular, the illustrated system enables a wireless telephone customer to recharge a pre-paid wireless calling account (hereinafter “pre-paid account”). Other potential uses for the illustrated system are within the scope of the present disclosure.

A pre-paid account applies generally to any account that has been set up to hold a balance that can be debited while the account holder uses the associated cellular service (e.g., placing a call from a cellular telephone). A pre-paid account is distinguished by the fact that cellular service is paid for before the usage actually occurs. The embodiment illustrated in FIG. 1 allows a user to recharge a pre-paid account (i.e., increase the balance on a pre-paid account) using the same transactional modes available for other account transactions (e.g., ATMs, PCs, telephones, cellular phones, etc.).

The system illustrated in FIG. 1 includes a number of possible point-of-entry devices including an Independent Sales Organization (ISO) Automated Teller Machine (ATM) 100, a financial institution ATM 110, a Point-of-Sale (POS) terminal 120 and a PC-based terminal 130. The system of FIG. 1 can also be configured to work with a Cash Accepting Device (CAD) 140 or a Web-enabled phone 150. It should be appreciated that the point-of-entry devices illustrated herein are exemplary and should not be viewed as limiting. Suitable point-of-entry devices additionally include, but are not limited to, wireline telephones, wireless telephones, handheld devices, etc.

Each point-of-entry device is coupled to a network. Depicted in FIG. 1 with respect to the various point-of-entry devices, the networks include Public Switched Telephone Network (PSTN) 200, Local Area Network/Wide Area Network (LAN/WAN) 210, private network (PVT) 220, 222, and the World-Wide-Web (WWW) 230. It should also be appreciated that the particular point-of-entry device/network combination is in no way limited to the particular combinations illustrated in the exemplary configurations of FIG. 1. For example, an ATM might be connected to a private network, while a PC might be Ethernet-connected to the Internet. A cellular phone 150 might have a wireless connection to a cellular network and a handheld device may have a wireless connection to the Internet. A CAD might be connected to the PSTN. Any suitable combination of point-of-entry device and network capable of capturing and transmitting input information should be considered as contemplated by the presently disclosed invention.

The account-related tasks which can be implemented by a user will depend upon the input device itself as well as the status of the account. ATMs may enable account status inquiries and/or recharge capabilities, whereas a PC may enable a greater range of tasks. The status of the account in this context pertains to the hosting entity. If the account is hosted by the entity which implements the transaction processing platform 500 as presently disclosed, a greater range of account related functions may be enabled. In contrast, if an account is remotely hosted, only limited tasks, such as account validation and recharge, may be enabled. The various hosting scenarios and possible tasks are described in more detail below.

Each of the previously described networks is in turn coupled to a processor. PSTN 200 and LAN/WAN 210 are shown connected to transaction switch 300 which is coupled to a funds processor 305. The transaction switch 300 may be implemented in a variety of ways. For instance, in one embodiment, the transaction switch 300 is a server running BASE24® (ACI Worldwide Inc., Omaha, Nebr.) transaction processing application software. The transaction switch 300 may also function as a switch for exchanging data between a funds processor 305, such as a bank associated with a bank card inserted into the ATM 100, 110, and the remainder of the system for altering an account. In a further embodiment, the transaction switch 300 simply implements the BASE24® functionality, and the switching functions are implemented elsewhere in the system.

In one embodiment, the transaction switch 300 communicates with a Virtual Private Network (VPN) 296 for establishing a secure Hypertext Transfer Protocol (HTTP) connection with a transaction processing platform 500, to be described in detail below. In another embodiment, the transaction switch 300 is provided with a separate communications pathway to the transaction processing platform 500 over which a secure connection is established using another protocol. In FIG. 1, a secure Transmission Control Protocol/Internet Protocol (TCP/IP) socket connection is employed for such secure communications over the dedicated line. Appropriate server and client software is employed to realize the secure socket connection, as known to those skilled in the art. Other similar secure protocols may be employed.

Private networks 220, 222, the WWW 230, and the PSTN 240 are respectively connected to third party processors 284, 280, 282, 286. Each processor is then connected to a VPN 290. The processors 280, 282, 284, 286 are used to run applications necessary to communicate over the VPN 290.

An additional type of point-of-entry device is a variant on the previously described PC 130. In this case, a PC 160 is provided with the interface software necessary to communicate directly with the transaction processing platform 500. In other words, an intermediate processor 280, 282, 284, 286 is not required if the input device 160 is properly configured.

A VPN refers to, in general, a group of two or more computer systems, typically connected to a network built and maintained by an organization or company solely for its own use with limited public network access. VPNs may exist between an individual machine and a private network (client-to-server) or a remote LAN and a private network (server-to-server). VPNs typically provide a high level of security features including encryption, strong authentication of remote users or hosts, and mechanisms for hiding or masking information about the private network.

VPNs 290, 296 are coupled to the transaction processing platform 500 through a firewall for providing a secure interface between the VPNs and a payment gateway 520. The hardware implementing the payment gateway 520, such as a server computer, may also support the firewall functions. Alternatively, a separate processor may be employed for providing the firewall functionality. The payment gateway is the central actor in the presently disclosed system and is used to execute certain software applications.

The payment gateway 520 is in communication with account databases 530. The account databases 530 store account data for accounts maintained by the entity which operates the transaction processing platform 500 (“domestic accounts”). In an exemplary embodiment, the operator of the transaction processing platform 500 is a billing services provider and the account databases 530 are used to maintain subscriber accounts for one or more clients of the billing services provider.

The payment gateway 520 is also connected to an MDN master database 540. The MDN master database contains the association information for each supported MDN. It is in communication with a File Transfer Protocol (FTP) portal 580 to enable updating by foreign account 700 hosting systems (such as billing databases, billing systems, or other account repositories) via VPN 712, as described in further detail below. The payment gateway 520 of the transaction processing platform 500 is also connected to the external account 700 systems via VPN 710.

In the illustrated embodiment, the account databases 530 and the MDN master database 540 appear as discrete elements. It will be appreciated, however, the databases may reside contiguously within a storage element or elements, or in fact may be co-mingled. Thus, it is to be understood that the databases of the presently disclosed system are virtual elements which may or may not have separate physical implementations.

The payment gateway 520 is additionally connected to a transaction store database 560 which is utilized to keep records of transactions implemented by the payment gateway 520 and to forward transaction information to external reconciliation and settlement systems 690.

The payment gateway 520 also has an Internet or similar secure network connection to a database of Personal Identification Numbers (PINs) generated by a server 722 running PIN generation and distribution software, as known to one skilled in the art.

A number of software modules are executed by the payment gateway 520 in order to facilitate various exchanges of information. The following is a discussion of each such module and the data exchanged by each.

To enable external systems to query and modify data and initiate account transactions, the payment gateway 520 employs one or more means of access. For example, the payment gateway may employ a socket-based, proprietary Application Programming Interface (API), in communication via TCP/IP. In addition, the payment gateway runs an Extensible Mark-up Language (XML) API. The XML API, also referred to as the XML portal, is designed to provide an interface for external systems (e.g. systems associated with any of the illustrated input devices 100, 110, 120, 130, 140, 150, 160) to query and modify specific subscriber information in the internal and external databases 530, 700 using XML transactions. The XML transaction set, sent and received over an Internet connection, provides a vehicle for direct, secure communications between the billing services provider operating the payment gateway and client companies (hereinafter referred to as “clients”). Client company subscribers (hereinafter referred to as “subscribers”) can also be provided with account access through these means.

XML transactions are performed in a request/response mode. Client software sends XML requests to the XML portal run by the payment gateway 520. If a request is properly formatted, the XML portal returns a response containing the requested information. If a request is improperly formatted, the XML portal returns an error message indicating why the request could not be fulfilled.

Predefined payment management transactions supported by the XML portal include various account inquiry, setup and replenish transactions. For example, to perform an inquiry about a subscriber's shipping profile, a client representative or subscriber sends a “profile inquire request” message to the XML portal implemented by the payment gateway 520. At the payment gateway 520, a translation object sends the XML request to an XML Document Object Model (DOM) object for interpretation. The result is parsed and the appropriate database interface object is invoked to perform the requested transaction. The Component Object Model (COM) object validates the request then looks up the requested subscriber profile record in the MDN master database 540 then forwards the request to the subscriber's active database per the MDN database record. The COM also formats a “profile inquire response” message and returns the message to the remote user through essentially the reverse of the request receipt procedure. Regardless of the validity of the XML request, the COM object generates an XML string in response and initiates its return to the client in reverse order of the request flow. Every XML request message begins with an XML version number, a user ID, and a password in order to establish a secure connection to the XML portal. Other fields typically included in the message include an MDN as the account identifier and a subscriber-specific security code and/or a requester pass-code for authenticating the remote user performing the transaction. The user of the input device is normally requested to enter their MDN as part of the transaction. However, in the case of a request for account access originating from a device such as a Web-enabled phone such as the illustrated phone 150, the serving network already has an identification of the user through a value such as the Mobile Identification Number (MIN) or International Mobile Subscriber Identity (IMSI). These values are passed to the transaction processing platform 500 instead of the MDN, and the platform refers to data associated with the MDN master database 540 for resolving the MIN/IMSI data into a corresponding MDN.

For credit card account initiation transactions, the remote user provides the credit card number and related data (e.g., expiration date, sequence, holder name, address and phone, etc.) and a comment string. For replenish account request transactions, replenishment details including choice of credit vehicle (e.g., prepaid card, cash, credit card), amount, specific credit vehicle identification, pass-code, applicable taxes, and a unique transaction identifier which can be used in case a reversal of the replenishment operation is required.

As indicated above, a response to an XML request may include an identification of the status of a subscriber account. Such status may take the form of: active (i.e., the associated MDN can be used to send and receive calls); associated (i.e., the account is associated with the specified MDN); expired; canceled; or suspended.

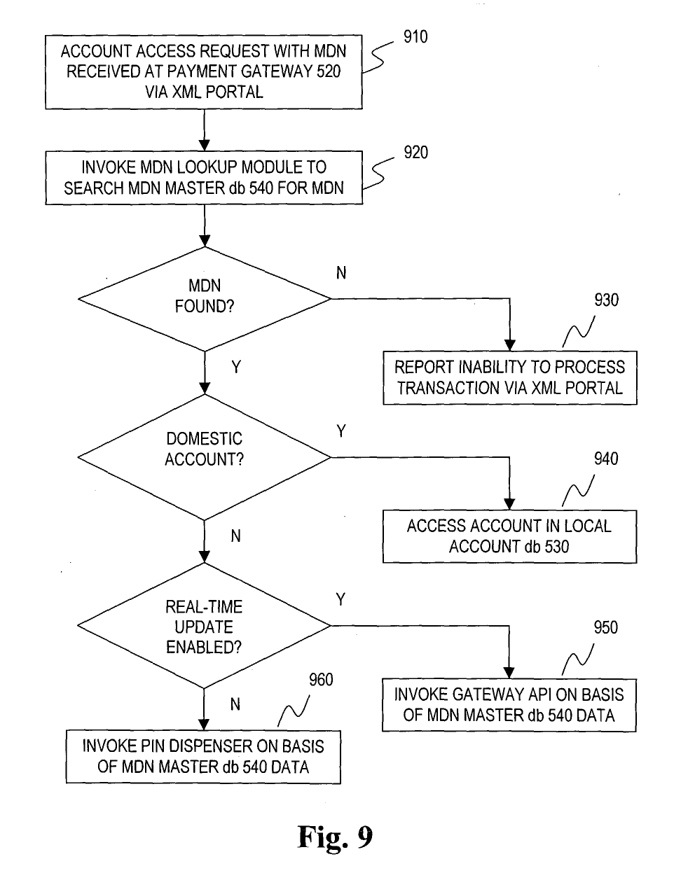

The flowchart of FIG. 9 is referenced in the following discussion. Once the payment gateway 520 has received an MDN and an associated request 910, it must determine where to access the account. The answer to that inquiry will determine what action can be taken with respect to the account. The software which enables the payment gateway to retrieve the data necessary to access accounts is referred to as an MDN lookup module, or more simply as the MDN lookup. The MDN lookup is responsible for sending MDNs received by the payment gateway to the MDN master database 920 and for identifying whether a particular MDN has been located in the MDN master database 540. An error is reported by the MDN lookup if the MDN is not found 930.

In the case where the billing services provider operating the payment gateway maintains accounts for a set of subscribers of a client company (i.e., domestic accounts), the account records are maintained in the local account database(s) 530, 940. As noted above, the account and MDN master databases are logical constructs and may be physically provided on the same or separate media. The MDN-associated data from the MDN master database 540 in this case would direct the payment gateway 520 to execute software which addresses the account databases 530 using the MDN at issue in order to access the respective account.

In two further scenarios, as initially described above, the billing services provider does not host billing records for subscribers of two other classes of companies. Subscriber accounts for these client or non-client companies may be referred to as “foreign accounts.” One class of companies hosting foreign accounts 700 has established a relationship with the billing services provider whereby the latter can exchange subscriber account data with the respective foreign account in real time. In order to enable such real time data exchange, the MDN-associated data from the MDN master database 530 provides an identification of the serving carrier. The MDN-associated data further provides instructions 950 to the payment gateway 520 for executing software for interactively accessing the hosting company's data, and specifically the account location and other data associated with the MDN in question.

The other class of client or non-client companies hosting foreign accounts 700 has not enabled real-time access to foreign subscriber accounts by the billing services provider. In the case where account replenishment of such a subscriber's account has been requested, MDN-associated data from the MDN master database 530 identifies the serving carrier and instructs 960 the payment gateway to execute software which requests an electronic Personal Identification Number (PIN) from the PIN database 720. The PIN database 720 itself may be hosted as part of the transaction services platform 500 or may be provided by a third party. The payment gateway is programmed to determine if a PIN having a set amount of credit associated therewith is available in exchange for the credit vehicle offered by the remote subscriber. The billing services provider thus acts as a purchaser of the PIN for the remote subscriber: it receives a recharge request from a remote subscriber, validates the funds exchange offered by the subscriber, credits the funds to the billing services provider, contacts the proper PIN database or repository identified on the basis of the MDN lookup, and returns the purchased PIN to the remote subscriber. The remote subscriber must then use separate communications channels to submit the PIN to the respective carrier to cause the associated credit to be associated to the subscriber's account.

PINs reside in one or more PIN databases 720 which may be managed by the service provider or by third parties. The PINs are or will be associated with a respective client or non-client company and are utilized as recharging means supported by the transaction processing platform 500. PINs are introduced into the PIN database(s) 720 from any PIN source 722 supported directly or indirectly (i.e., via third parties) by the respective client or non-client companies. The PINs are then ready to be provisioned for association with domestic or user accounts.

The MDN master database 540 is maintained through the periodic provision of updated account location information received by the FTP portal 580 from the non-client companies 700. Similar mechanisms are employed for updating the MDN master database with data from client companies. The FTP portal is responsible for associating MDN-related account location information with the local configuration, carrier ID, and access information pre-programmed by the transaction processing platform 500 operator.

Under certain circumstances, the mechanisms which interface to the presently disclosed payment gateway (e.g. mobile device or phone 150) may provide a Mobile Identification Number (MIN) or International Mobile Station Identity (IMSI) instead of the Mobile Directory Number (MDN). The MIN/IMSI uniquely identifies a mobile unit within a wireless carrier's network. The MDN, on the other hand, identifies a subscriber (individual or entity). The MDN master database 540 in a preferred embodiment is also programmed with data for establishing the correspondence between MIN/IMSI values and MDNs, thus enabling access to subscriber accounts using MDN or MIN/IMSI. This correspondence data is collectively referred to as a Telephone Number Inventory (TNI). Update information is received periodically from foreign account 700 hosts via a VPN connection 712 and FTP portal 580 to the MDN master database 540.

The mechanism associated with the payment gateway 520 for exchanging real-time data with foreign accounts 700 is referred to as the gateway API. In short, the gateway API sends an account inquiry to the entity hosting the foreign account 700 on the basis of MDN-specific data from the MDN master database 540 (for example, via VPN 710), and waits for an indication that the account in question is in good standing. Next, the gateway API sends the specific account related request. In one embodiment, such requests include: an account inquiry to verify an account is active and that a specified recharge can be accomplished; an account replenishment instruction to update a prepaid foreign account by the specified amount; and a conditional reversal instruction to reverse a foreign account recharge in the case of a system failure. The latter may be caused, for instance, by a disruption in the communication between an ATM 100, 110 and the payment gateway 520. As with XML portal exchanges, user names and passwords are required for authentication purposes. Once the gateway API receives confirmation that the account has been updated, the XML portal issues confirmation back to the remote requester (located for example at the ISO ATM 100) indicating that the transaction was completed. Communication between the payment gateway 520 and the foreign accounts 700 is via secure, dedicated connection 710 in one embodiment, and via Secure Sockets Layer (SSL-secured) Internet connection (not shown) in another.

The data to be included in an exchange from the payment gateway 520 to a foreign account 700 via the gateway API include the authentication information, an identifier of the transaction type, the MDN, the recharge amount, a unique transaction identifier, and a date/time stamp. In one embodiment, the foreign account 700 host responds with authentication information, the result of the gateway API requested action, the expiration of the new balance, carrier messaging to be conveyed to the remote requester, the transaction identifier previously defined by the gateway API, and an optional carrier transaction identifier.

The mechanism allowing the payment gateway 520 to alter foreign accounts 700 other than in real-time is referred to as an electronic Personal Identification Number (PIN) dispenser 960, hosted by the payment gateway 520. The data associated with the MDN in this situation is an identification of the serving carrier and a logical address for a PIN database 720. As previously indicated, the PIN database 720 may be hosted by a third party and accessible such as via the Internet, as shown in FIG. 1, or may be hosted by the transaction processing platform 500.

The payment gateway 520, executing the PIN dispenser module, determines if a PIN (previously generated and supplied by a PIN source 722) is available for the amount of the request, and if so, the PIN is returned to the payment gateway 520. The payment gateway 520 then returns the PIN to the requester via the XML portal. The requester may thereafter use the PIN to recharge the respective account off-line, such as through calling a toll-free number and entering the PIN using a telephone keypad.

Data submitted to the PIN dispenser module includes the subscriber's carrier identification, subscriber-requested PIN denomination, and a transaction identifier. It is unnecessary for the payment gateway to provide an account identifier since association of credit with user account is done off-line. If the PIN can be provided, the PIN is retrieved along with respective control and batch numbers, a PIN value, an expiration date, the carrier identifier, and optionally carrier messaging such as a toll-free number that the requester can call to recharge an account using the PIN. The XML portal, running on the payment gateway 520, returns the PIN and messaging data to the requester, and a record of the transaction is recorded in the transaction store 560 associated with the payment gateway 520. In case of a time-out or communications failure, the PIN dispenser module causes a reversal request to be issued to the PIN database 720 with the control number and transaction identifier. A record of the entire transaction including a confirmation is then returned to the payment gateway and recorded in the transaction store 560.

Periodically, the PIN generating entity 722 will provide a record of its current PIN inventory for reconciliation with the reconciliation and settlement system 690 associated with the transaction processing platform 500. In one embodiment, this occurs monthly.

The transaction store 560 enables the transaction processing platform 500 to track and report payment transactions processed by the payment gateway 520 and the XML portal. To comprehensively track all payment services transactions and to enable customer service representative access to such information, a record keeper API is implemented on the payment gateway 520. Transaction records are preferably sent to the transaction store 560 by the record keeper API for the following transactions: successful domestic and foreign account recharge; successful domestic and foreign transaction reversal; failed account database account inquire or replenishment; failed foreign account inquire at MDN lookup; failed foreign account replenishment request at gateway API; successful PIN dispense; and unsuccessful PIN dispense (no PIN available or communications failure). Other transaction records may also be recorded as dictated by the needs of the transaction processing platform and the non-client companies.

Exemplary transaction store 560 record data includes: transaction type and status (successful or failed); account result (e.g., active account, account updated, none); XML portal transaction identifier; MDN; carrier code; PIN, PIN batch ID and PIN control number; date/time stamp; XML user ID; recharge and tax amount; authorization code; partner agent and terminal ID; terminal zip code; and a transaction status log including date/time stamps for individual steps in the respective transaction.

On a periodic basis, such as once per day, extracts from the transaction store 560 are provided to a reconciliation and settlement system 690 for non-real time settlement with non-client company information.

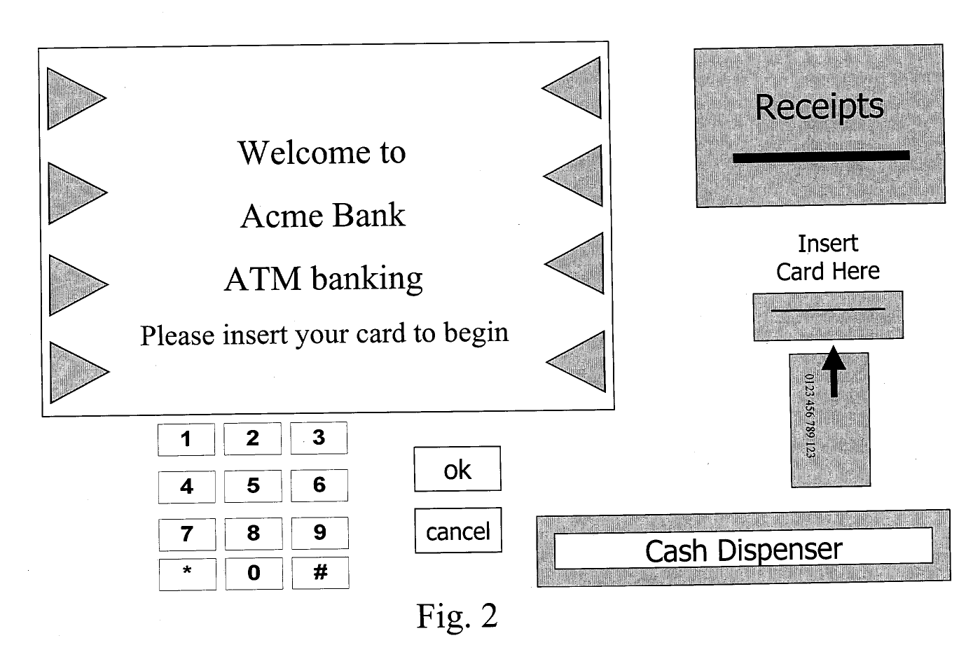

One exemplary situation that utilizes the present invention arises wherein a prepaid cellular customer desires to recharge a prepaid account from an automatic teller machine (ATM). For purposes of illustration, a recharge transaction will be described in connection with the financial ATM 110 as the point-of-entry device. FIGS. 2-8 schematically depict the ATM from the point of view of a user enacting a recharge transaction.

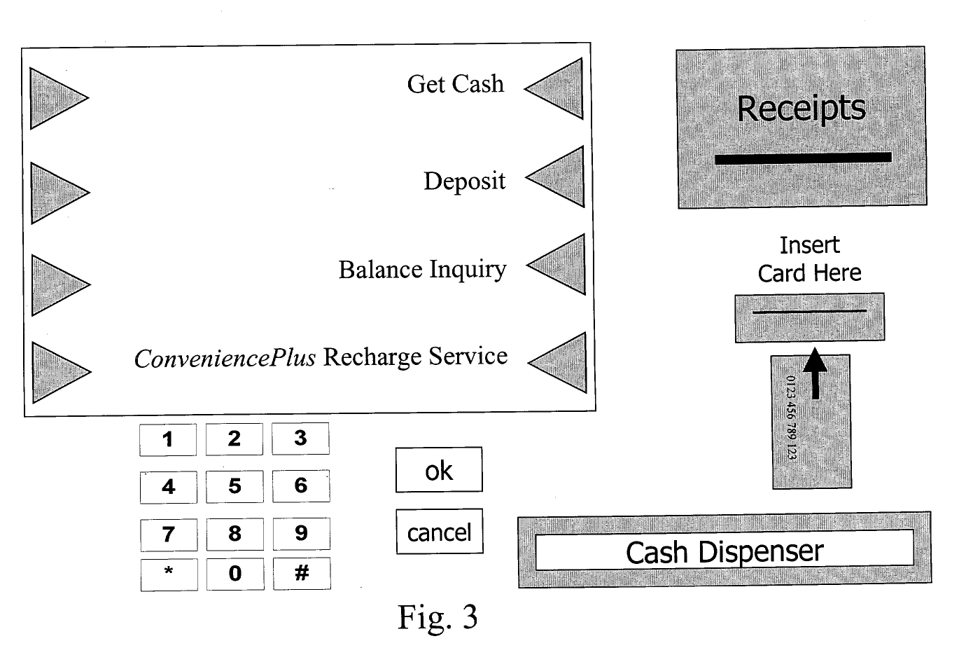

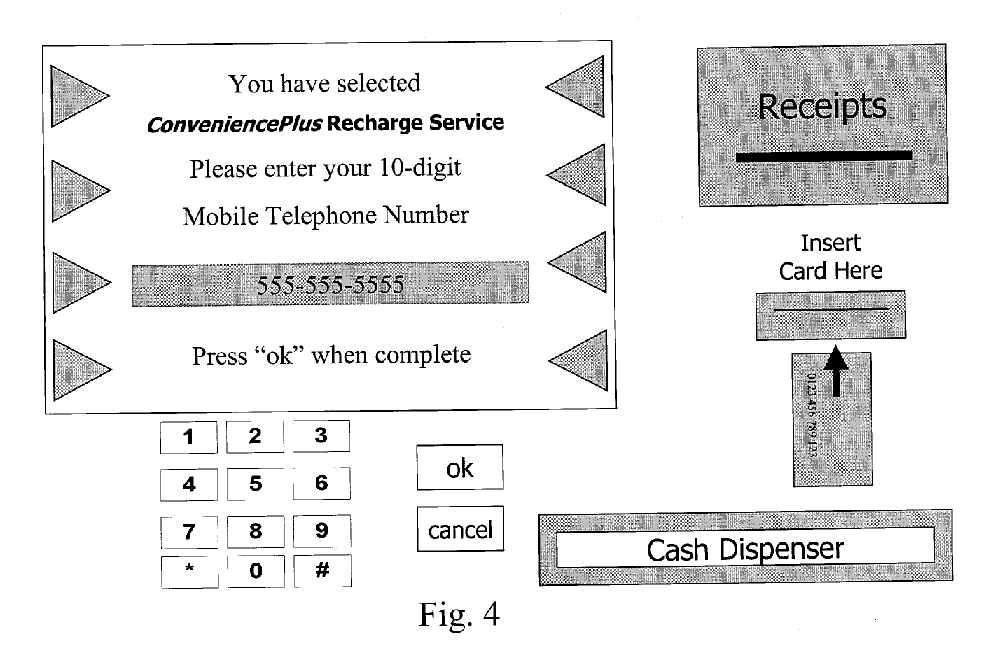

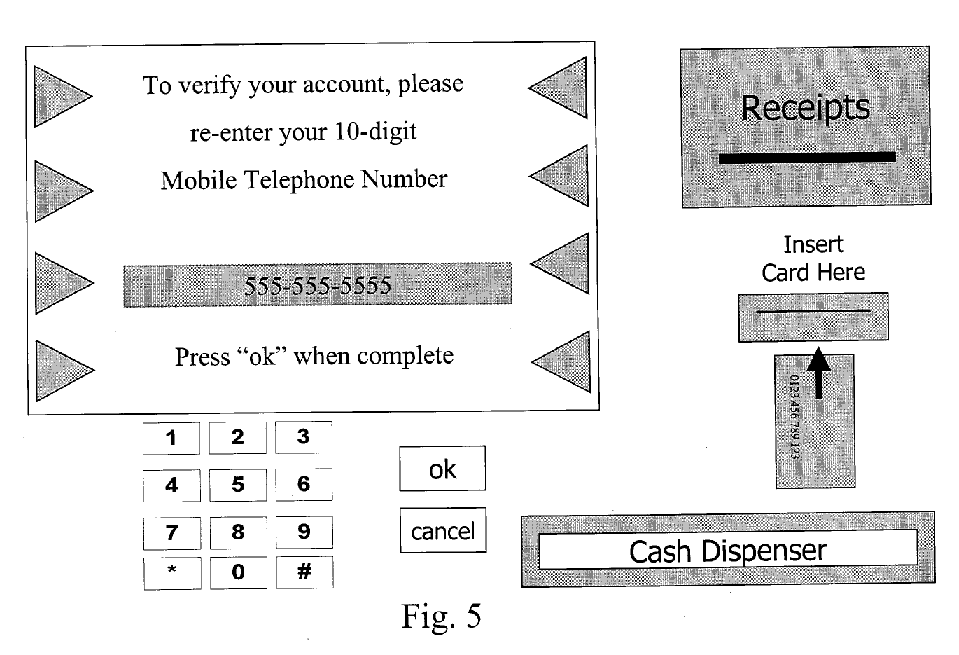

FIG. 2 illustrates an ATM 110 displaying a welcome screen typical of conventional ATM machines. In this illustration, the operator of the ATM, “Acme Bank,” is providing its own display information. FIG. 3 illustrates a possible menu screen appearing after a valid debit or credit card has been inserted and verified by the ATM. The menu includes standard options routinely available on ATM machines. Additionally, the ATM provides an option labeled as “ConveniencePlus Recharge Service.” “ConveniencePlus” is a brand name associated with the transaction processing platform 500 of FIG. 1. After selecting this option, the ATM may request a mobile telephone number corresponding to the account to which a recharge amount is to be added, as shown in FIG. 4. The terms mobile directory number (MDN) and mobile telephone number are used interchangeably. Upon entering an MDN, the ATM may ask for verification of the number for reasons of security and accuracy, as shown in FIG. 5.

The verified number is then transferred from the point-of-entry 110 along with any associated transaction information through the LAN/WAN network 210 to the transaction switch 300. Transaction information applies generally to any information needed at any stage of a transaction to successfully enact the transaction. Transaction information may include the account information of a bank debit account or bank credit account (e.g. VISA® (Visa International Service Organization, Foster City, Calif.) or MasterCard® (MasterCard International Incorporated, Purchase, N.Y.) branded) associated with the card inserted into the ATM. In addition, transaction information may include verification flags, encryption data, routing numbers, status information, transaction identification or any other information relevant to enacting a requested transaction. Additional transaction information may be generated at any stage of the transaction.

The transaction switch 300 interprets the transaction type selected by the user at the ATM and initializes a transaction. In one embodiment, the transaction switch 300 opens a transaction with a debit account associated with the debit card inserted into the ATM 110 by communicating with the funds processor 305. In addition, the transaction processing platform 500 is identified (by switch 300 or processor 305) as the destination of the MDN and the transaction information relating to the current transaction.

In a first embodiment, the MDN and any associated transaction information are transferred through the VPN 296 using HTTP to the transaction processing platform 500 in general, and the payment gateway 520 in particular, using the XML portal. In a second embodiment, the data exchange is via secure TCP/IP protocol. The payment gateway 520 may support a firewall module for examining certain parts of the transaction information to verify the transaction is authorized to access to the payment gateway 520.

The payment gateway 520 processes the MDN to ascertain the location and identity of the associated account. In a first step, the payment gateway uses the MDN lookup function to query the MDN master database 540. The MDN master database 540 responds to the MDN lookup by providing the carrier and instructions necessary to cause the payment gateway to access the account associated with the MDN.

If the MDN master database 540 responds that the billing services provider hosting the payment gateway maintains the account related to the MDN in the domestic account database 530, then the payment gateway 520 causes the transaction to be executed locally, with appropriate interaction with the requester at the ATM 110 via the XML portal.

In an alternative embodiment, the payment gateway 520 is programmed to determine if the MDN (or MIN/IMSI) is associated with a domestic or foreign account, for instance by reference to a separate, locally maintained database. If associated with a domestic account, the payment gateway would not invoke the MDN lookup module and would directly address the domestic account databases 530. If not identified as a domestic account, the payment gateway 520 would invoke the MDN lookup module, as above.

If the MDN master database 540 identifies a foreign account for which real-time payment gateway 520 account access has been enabled, the payment gateway uses the gateway API, as instructed by the MDN master database instructions, to carry out the necessary interaction the initiating requester at the ATM 110 via the XML portal and with the foreign account.

If the carrier associated with the MDN has not enabled real-time access of its accounts by the payment gateway 520, the MDN master database record associated with the MDN returns the carrier ID, payment gateway instructions to invoke the PIN dispenser module, and logical address of the particular PIN database 720. The payment gateway then invokes the PIN dispenser module for retrieving the requested PIN, if available. The PIN and related data, including appropriate carrier-specific messaging, are then returned to the requester at the ATM 110 via the XML portal.

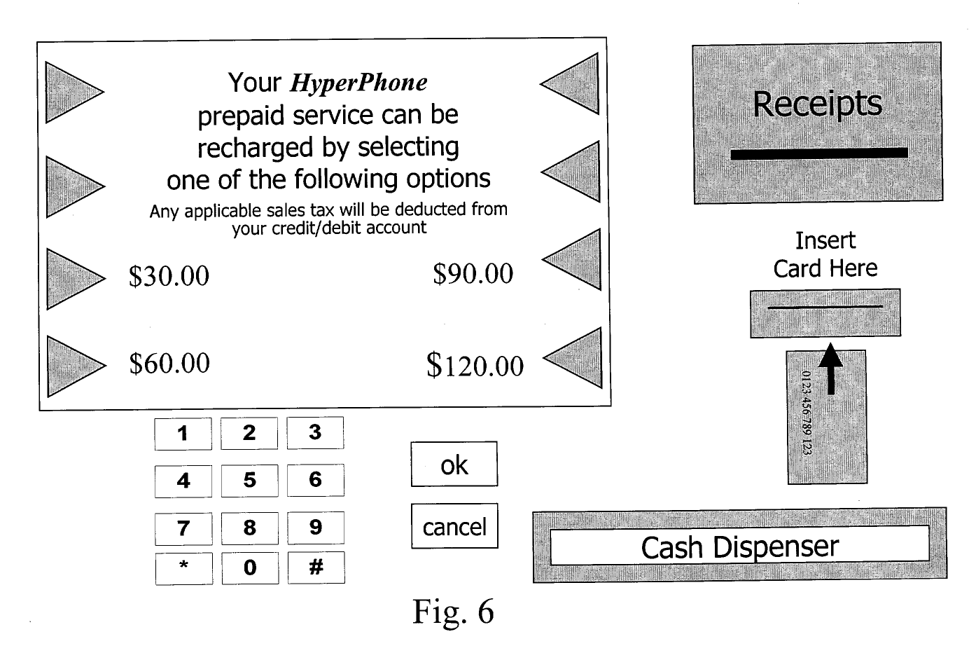

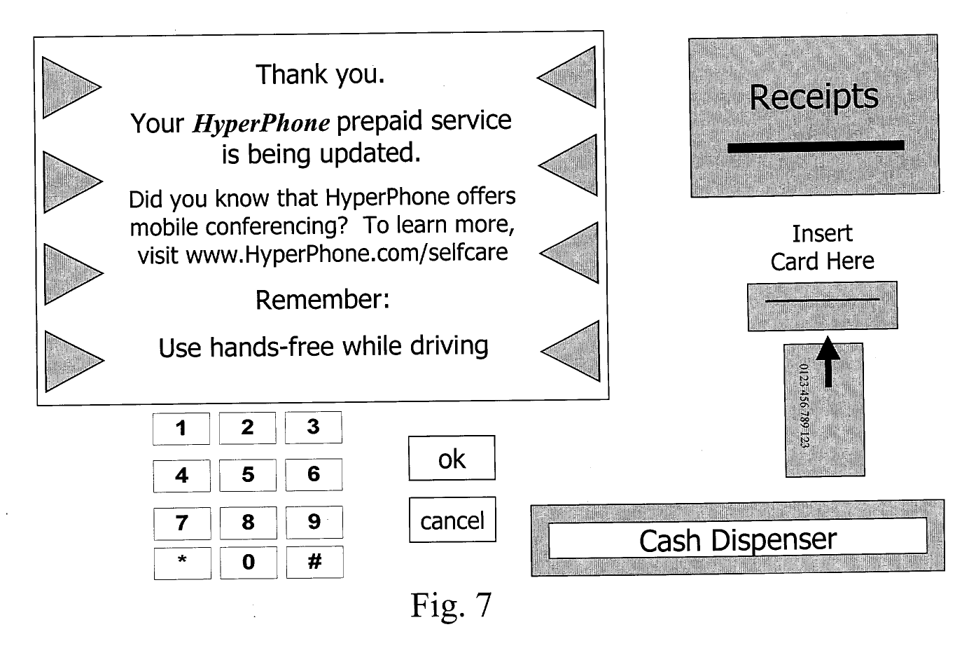

In each of these cases, data is returned to the requester at the ATM 110, including carrier messaging and allowable recharge amounts. In FIG. 6, the carrier “HyperPhone” has provided the ATM with its name for insertion into the display, along with allowable recharge amounts (i.e., $30.00, $60.00, $90.00, and $120.00). In FIG. 7, the company name is again inserted into the screen display along with a message advertising mobile conferencing services.

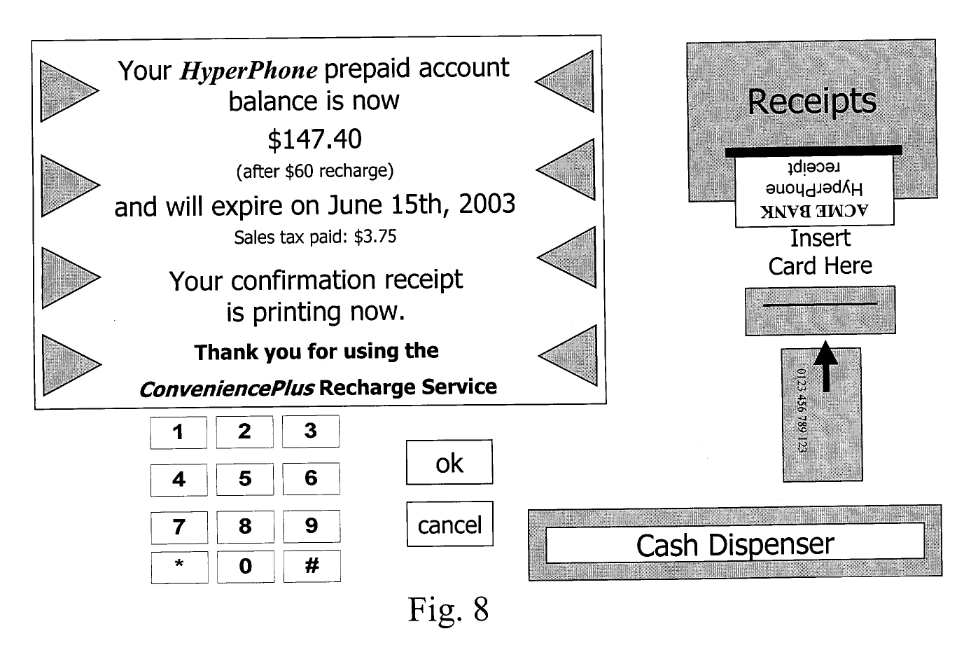

Depending upon the transaction involved and local laws, the payment gateway may also be responsible for calculating applicable tax and for adjusting the recharge amount credited or the debit/bank account withdrawal in order to compensate for such a tax. FIG. 8 illustrates a display generated upon successful recharge. In this case, either an account hosted by the billing services provider in the domestic account database 530 was recharged, or a foreign account hosted by a carrier that allows real-time access by the payment gateway 520 was recharged. In this case, sales tax has been deducted from the debit/bank account in addition to the requested recharge amount. Preferably, the amount of tax deducted is detailed on the receipt provided to the user. The receipt typically provides a bank-related portion and a carrier-related portion. If a non-real-time recharge event had occurred, the requester would be provided with a PIN, such as printed on a paper receipt.

The foregoing examples have been primarily concerned with determining the status of an account or recharging or adding to an account. However, the presently disclosed system can also be used for enabling mobile commerce (“mCommerce”) transactions whereby a commercial establishment (not illustrated) sends a request to the transaction processing platform 500 for a withdrawal from a user account and instructions to credit a financial or other account associated with the commercial establishment. Once again, a telecommunications-related identifier such as a user's MDN or MIN/IMSI is employed by the platform 500 for locating and accessing the respective user account. Essentially the same steps are involved as with the examples.

Those skilled in the art will recognize various modifications to the invention that could be made without departing from the spirit and scope of the invention. It should therefore specifically understood that the invention is not to be considered as being limited to the precise embodiments set forth. In particular, various transactions to multiple types of accounts associated with a mobile directory number and identifiable through the use of a NP database have been contemplated. Particular implementation details and variations on the general underlying concepts should be considered within the scope of the invention.

What is claimed is:

1. A system for processing a request for altering an account associated with a user identifier, comprising:
a gateway processor for receiving the user identifier and the request for altering an account associated with the user identifier;
a correspondence database in communication with the gateway processor, the correspondence database associating each of multiple user identifiers with instructions for enabling the gateway processor to access a respective account;
a domestic account database directly accessible by the gateway processor and storing a first set of accounts;
a foreign account database accessible by the gateway processor through a communications network; and
a credit exchange facility accessible by the gateway processor either directly or through a communications network, the credit exchange facility for conditionally providing a credit-bearing data set upon request by the payment gateway,
wherein the gateway processor is capable of referring to one of the domestic account database, the foreign account database, and the credit exchange facility in response to receipt of a user identifier and an associated account alteration request.
